(19) United States
(12) Patent Application Publication
(10) Pub. No.: US 2025/0162506 A1
(43) Pub. Date: May 22, 2025

(54) DEPLOYABLE CART AND ORGANIZER FOR A LOAD FLOOR OF A VEHICLE

(71) Applicant: FCA US LLC, Auburn Hills, MI (US)

(72) Inventor: Cole T Schaenzer, Royal Oak, MI (US)

(21) Appl. No.: 18/512,577

(22) Filed: Nov. 17, 2023

(51) Int. Cl. B60R 5/04

(52) U.S. Cl. CPC B60R 5/041

(57) ABSTRACT

A vehicle includes a load floor in a cargo area and a first engagement member and a second engagement member disposed within the cargo area. The first engagement member is spaced apart from the second engagement member. A cart has a base, a first side slidably engaging the first engagement member and a second side slidable engaging the second engagement member. The cart comprises legs retractably extending from the base and wheels coupled to the legs.

### FIELD

The present disclosure relates to payload utilization for a vehicle, and, more particularly, to a deployable cart and organizer for the load floor of the vehicle.

### BACKGROUND

This section provides background information related to the present disclosure which is not necessarily prior art.

Vehicles typically have a trunk located in the rear of the vehicle or a load floor and/or a front trunk for carrying cargo. Moving cargo to and from the vehicle conveniently is important to many consumers. To provide a convenient way to utilize the load capabilities of a vehicle is desirable.

### SUMMARY

This section provides a general summary of the disclosure and is not a comprehensive disclosure of its full scope or all of its features.

In one aspect of the disclosure, a vehicle comprises a load floor in a cargo area and a first engagement member and a second engagement member disposed within the cargo area. The first engagement member is spaced apart from the second engagement member. A cart has a base, a first side slidably engaging the first engagement member and a second side slidable engaging the second engagement member. The cart comprises legs retractably extending from the base and wheels coupled to the legs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is modified perspective view of a front trunk having a simplified cart slidably extending therefrom.

FIG. 1B is a modified cart used in the front trunk of FIG. 1A.

FIG. 1C is a view of the front trunk with a cart showing legs being extended.

FIG. 1D is a partially folded view of the cart of FIG. 1C.

FIG. 1E is a perspective view of a cart having an alternate set of legs.

FIG. 1F is an end view of a cart showing the direction of foldability of the legs.

FIG. 2A is a perspective view of a cart partially extended from the load floor of a vehicle.

FIG. 2B is a rear view of a vehicle having a cart in a retracted position.

FIG. 3 is a perspective view of a cart for heavy duty hauling.

FIG. 4A is an end view of a cart having a toolbox integrated therewith.

FIG. 4B is a perspective view of the cart of FIG. 4A.

FIG. 5 is a perspective view of an alternate cart having a relatively flat top.

FIG. 6A is a perspective view of a cart that is collapsible.

FIG. 6B is a view of the cart partially folded.

FIG. 6C is a perspective view of the cart more folded than FIG. 6B.

FIG. 6D is a perspective view of the cart of FIG. 6A fully folded.

FIG. 7A is a cross-sectional view of a cart in a vehicle.

FIG. 7B is a top view of a cart disposed within a vehicle.

FIG. 7C is a side cutaway view of the cart within the vehicle.

FIG. 7D is a side view of a cart having an optional battery and motor configuration.

FIG. 7E is a side view of a latch used for a manual way to lock the legs.

FIG. 8 is an alternate side view of back extending legs that rotate 270°.

FIG. 9A is an end view of rails holding the cart within rails.

FIG. 9B is an example of two rail extendable system.

Corresponding reference numerals indicate corresponding parts throughout the several views of the drawings.

### DETAILED DESCRIPTION

Example embodiments will now be described more fully with reference to the accompanying drawings.

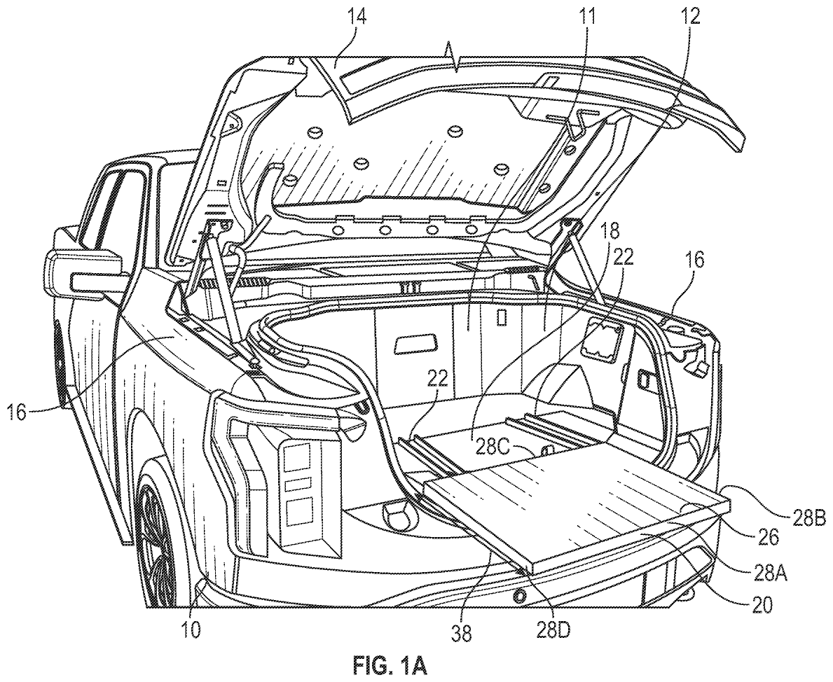

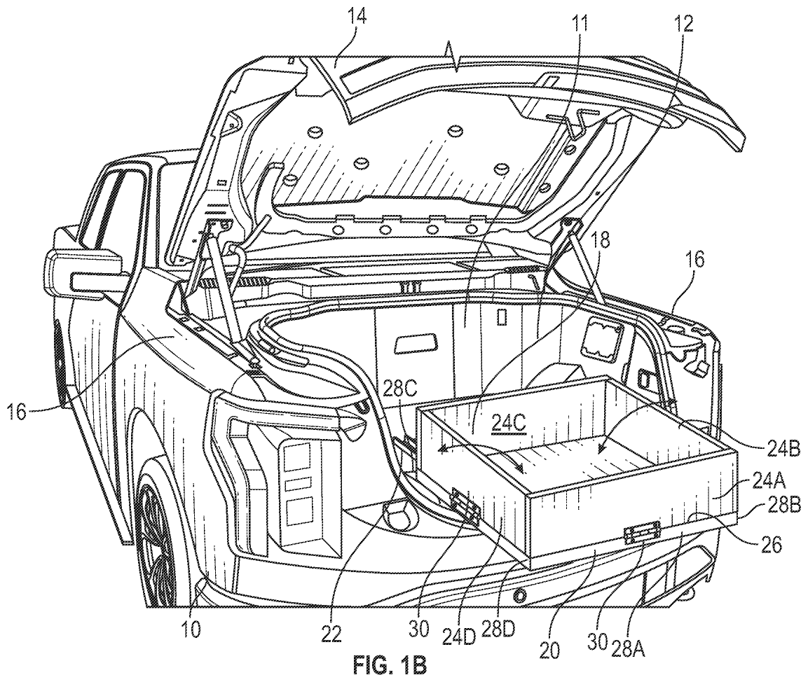

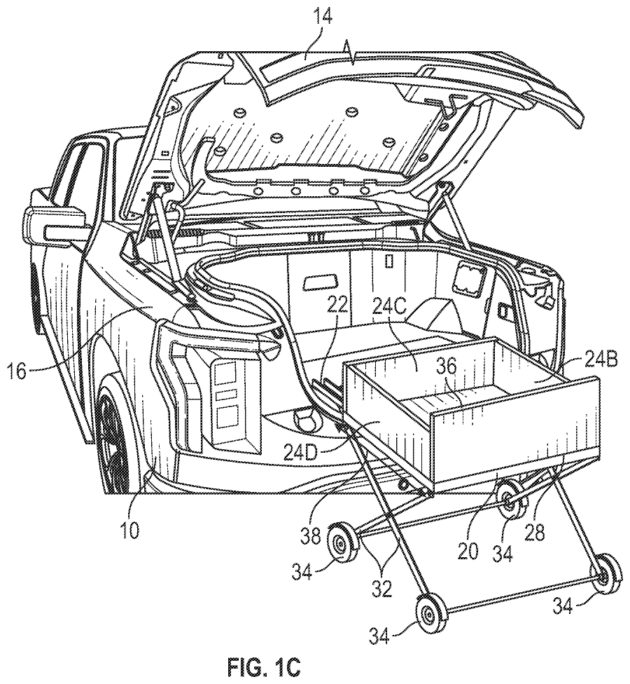

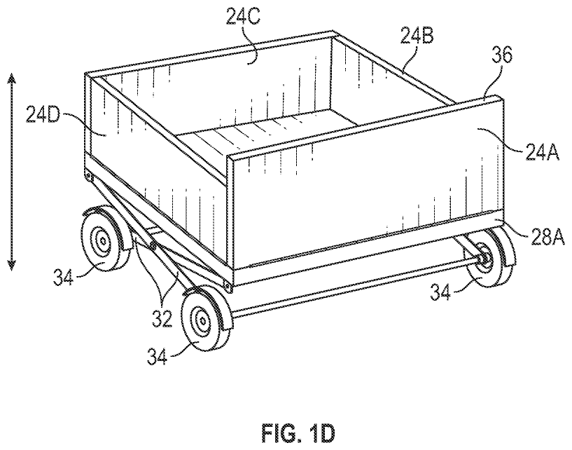

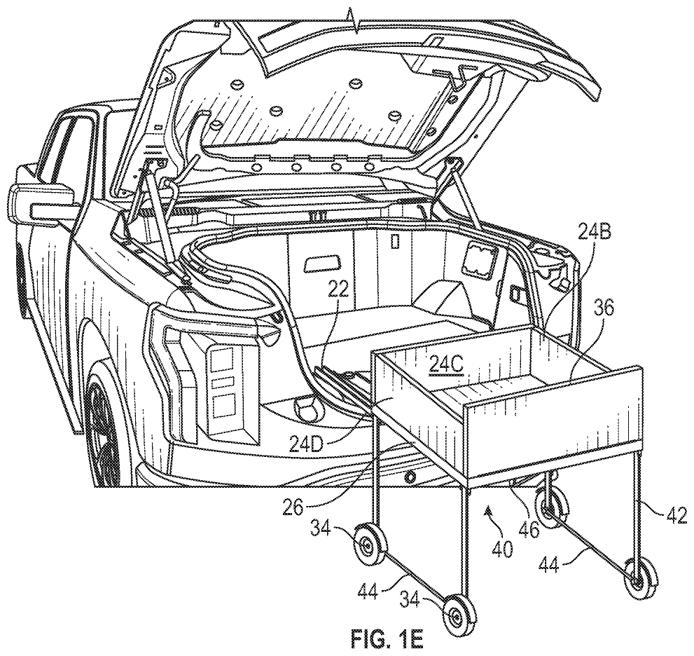

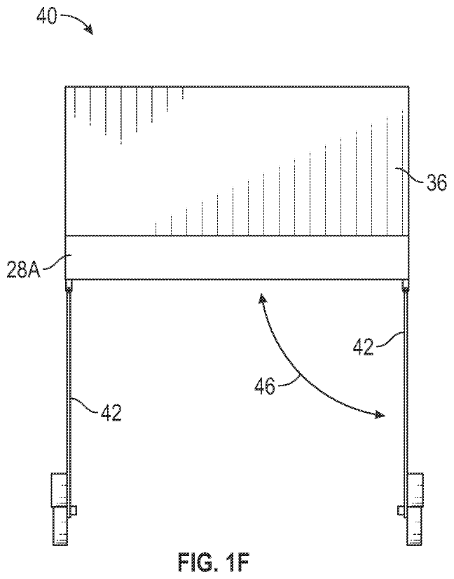

Referring now to FIG. 1A, a vehicle 10 having a cargo area 11 such as a front trunk 12 is illustrated. A front trunk 12 is provided in many battery electric vehicles. The front trunk 12 is enclosed with a hood 14. The front trunk 12 also has sidewalls 16 and a load floor 18. The load floor 18 is typically planar and is used to support objects referred to as the load of the vehicle. The load floor 18 in the present disclosure has a cart 20, a simplified version of which is illustrated in FIG. 1A with concealed wheels for supporting some or all of the load. The cart 20 is slidably fastened to the load floor 18 using rails 22 that are fastened to the load floor 18 or sidewalls as described in greater detail below. The cart 20 has a base 26. In the present example, the based 26 is also planar.

Referring now to FIG. 1B, the front trunk 12 with the load floor 18 is illustrated with a modified cart 20 with wheels concealed. In this example, the modified cart 20 has foldable walls 24A, 24B, 24C and 24D. The foldable walls 24A-24D extend in a vertical direction from the base 26. The base 26 has sides or edges 28A, 28B, 28C and 28D. The foldable wall 24A extends from the side or edge 28A and extends laterally relative to the cart and vehicle, foldable wall 24B extends from the side or edge 28B and extends longitudinally relative to the cart and vehicle, foldable wall 24C extends from the side or edge 28C and extends laterally relative to the cart 20 and vehicle 10 and the foldable wall 24D extends from the side or edge 28D and extends longitudinally relative to the cart and vehicle. Hinges 30 couple the edges 28A, 28B, 28C, 28D to the foldable walls 24A, 24B, 24C, 24D, respectively. The foldable walls 24, in the upright position, are used to hold loads and keep the loads on the base 26 of the cart 20.

Referring now to FIG. 1C, further details of the cart 20 are provided. In this example, the cart 20 has two sets of foldable legs 32 shown extended. The foldable legs 32, as illustrated in FIG. 1D, retract adjacent to or up inside the base 26. The foldable legs 32 have wheels 34 attached thereto. In the stored position at the load floor 18, the wheels 34 and foldable legs 32 are compressed adjacent to the base 26 as is illustrated in FIG. 1D. In FIG. 1D, the foldable legs 32 fold slightly further up under the base 26. In the example in FIGS. 1C and 1D, a handle 36 extends from the edge 28A. The handle 36 may be foldable in a similar manner to the foldable wall 24A. However, the handle 36 may be permanently and non-movably fixed to the edge 28A.

In the examples illustrated, the arrow 38 represents movement into and out of the front trunk 12 in a slidably outward direction. With the example relative to the front trunk 12, the arrow 38 is in a longitudinal direction toward the front of the vehicle 10.

In FIGS. 1C and 1D, the foldable legs 32 fold in a scissor manner.

Referring now to FIGS. 1E and 1F, another example of a cart 40 is illustrated. In this example, the base 26 is the same as the base illustrated above with the foldable walls 24B, 24C, and 24D and a handle 36. In this example, the cart 40 has legs 42 that extend in an extended position vertically downward. The legs 42 have cross-members extending between two adjacent legs. The longitudinal edges 28B and 28D are parallel to the cross-members 44 that join the left and right front most legs 42 and the front and rear right most legs 42. As illustrated in FIG. 1F by the arrow 46, the leg 42 fold into the base 26 in a direct lateral to the vehicle. That is, when the legs 42 are folded, they are in a lateral direction relative to the vehicle 10.

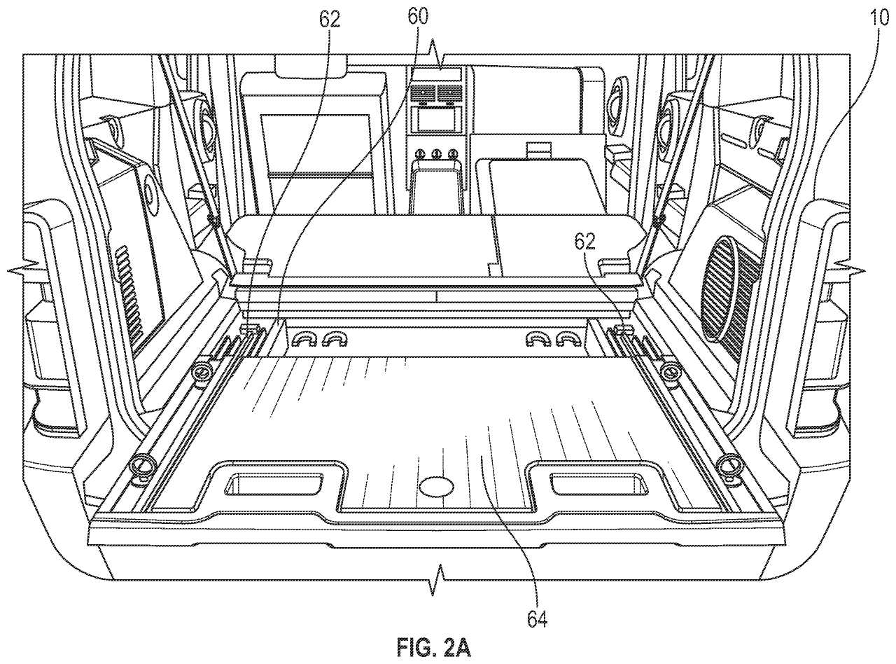

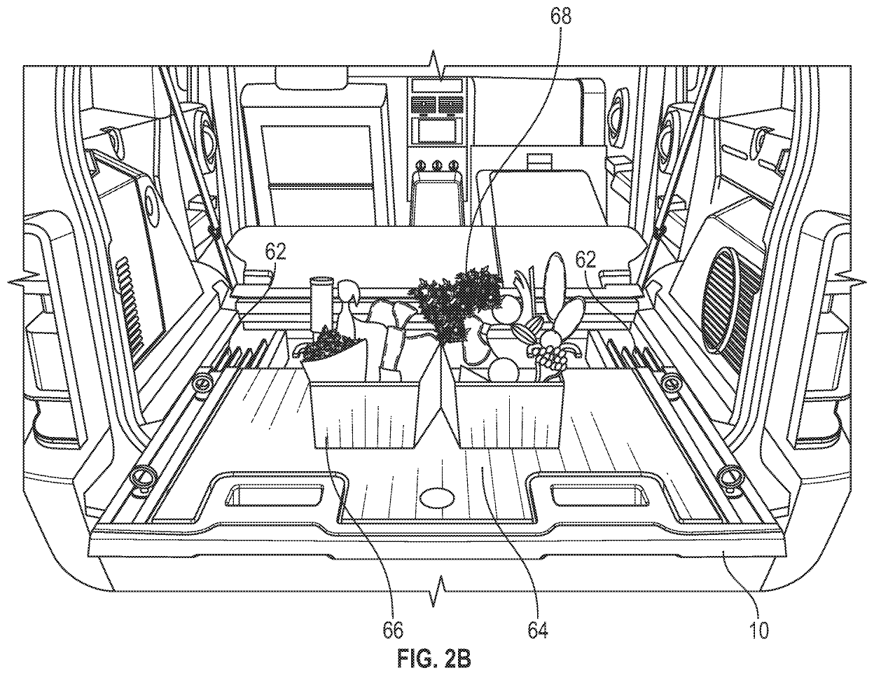

Referring now to FIG. 2A, another cargo area is a rear trunk or load floor 60 of the rear of the vehicle 10. The load floor 60 is illustrated having rails 62 embedded into the load floor 60. A cart 64 is illustrated partially slidably removed from the rear of the vehicle 10. The cart 64 is configured in one of the manners illustrated set forth above relative to FIGS. 1A-1F.

Referring now also to FIG. 2B, the vehicle 10 is illustrated with the cart 64 in the retractable position and having foldable walls 66. Further, in this example, the foldable walls 66 are in an upright position and hold a load 68. The load 68 is prevented from moving outside of the area or base 26 of the cart 64.

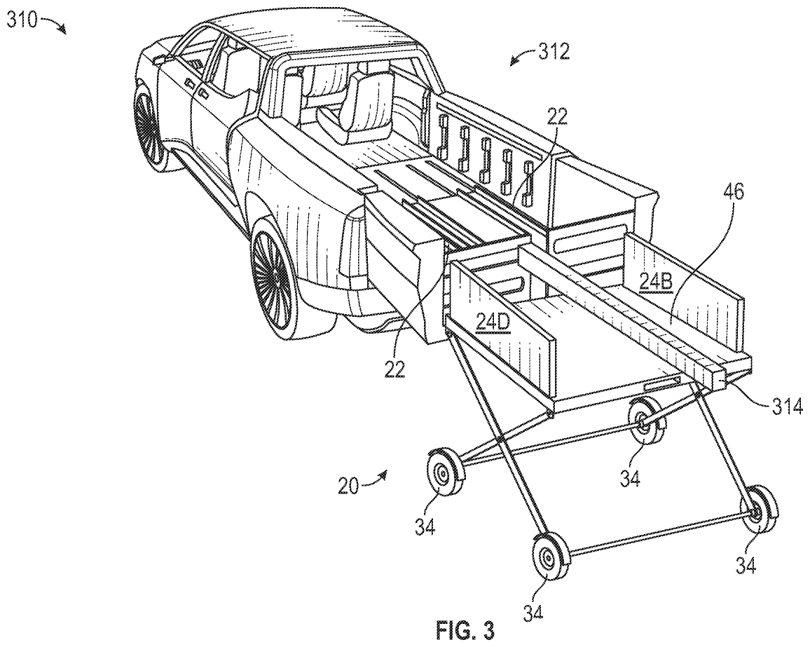

Referring now to FIGS. 3A and 3B, a pickup truck 310 is illustrated having the cargo area comprising a cargo bed 312. The bed 312 accommodates the cart 20 similar to that illustrated in FIG. 1C, and therefore are labeled with the same reference numerals. In this example, the cart 20 has foldable walls 24B and 24D extended in an upright position. This allows an extended load 314 to be placed on the base 26 of the cart 20. The vertical, lateral and longitudinal size of the cart 20 is adjusted for the size of the vehicle 10. For a front frunk 12, the cart is smaller than the cart used for the cargo bed 312 of a pickup truck 310. The cart 20 illustrated in FIG. 3A is an enlarged version of that illustrated in FIG. 1D and therefore is not illustrated again. In FIG. 1D, the cart has four foldable walls 24A, 24B, 24C, 24D. However, one wall is a handle 36 in FIG. 1D. In FIG. 3A walls 24A, 24C are removed or folded out of the way for simplicity. Rails 22 secure the cart 20 to the bed 312.

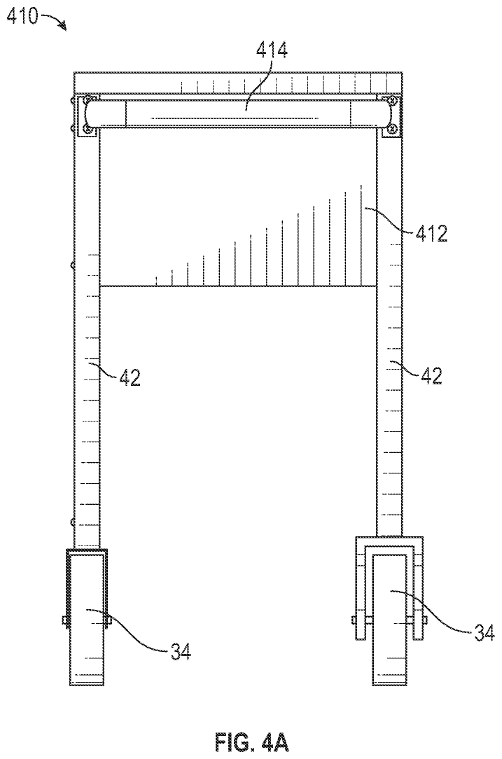

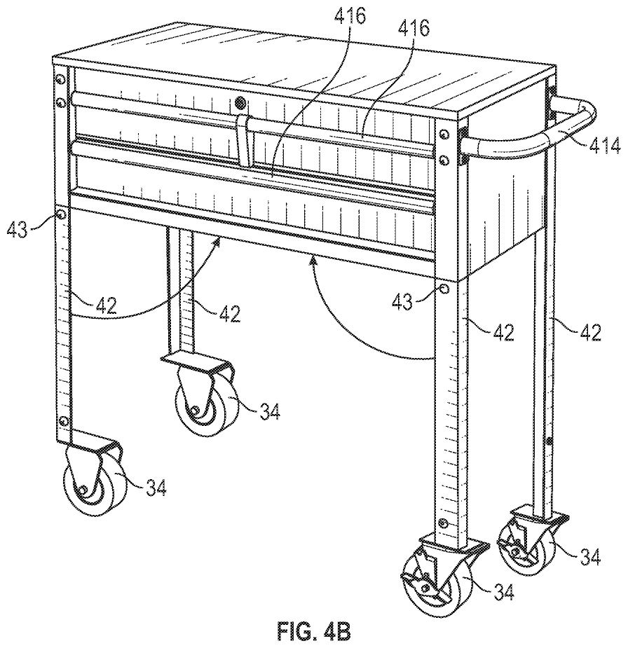

Referring now to FIGS. 4A and 4B, a cart 410 that has a toolbox 412 thereon is illustrated. The toolbox 412 includes a handle 414 and drawers 416. Of course, different configurations of drawer, bins and store portion are infinitely possible. The cart 410 engages rails within on the load floor 18 or sidewalls 16 of the vehicle 10 as described above and below. The cart 410 is similar to the cart 40 illustrated above in that the legs 42 are foldable below the toolbox 412 at the folding point 43.

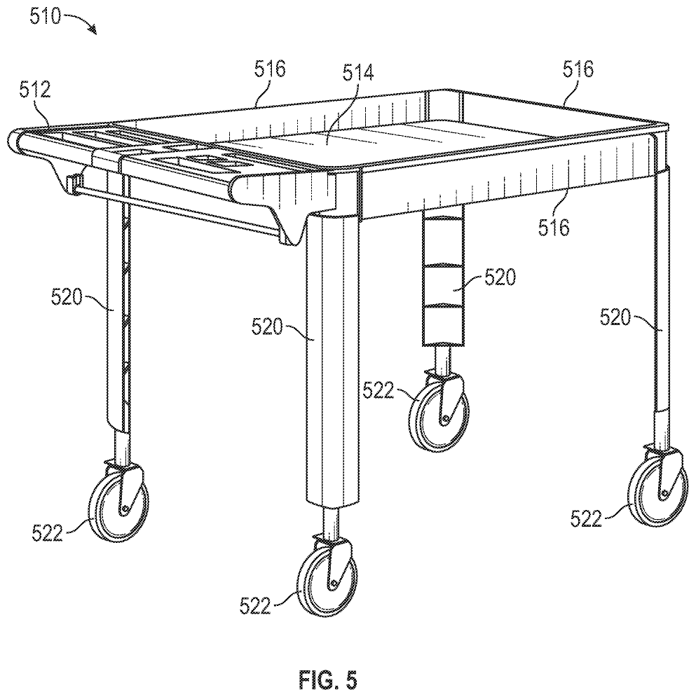

Referring now to FIG. 5, another example of a cart 510 has a flat handle 512 with a base 514 with small side walls 516 extending therefrom. The handle 512 forms one of the sidewalls. The legs 520 fold like the legs illustrated in FIG. 1F having the wheels 522 extending from each of the legs 520, respectively.

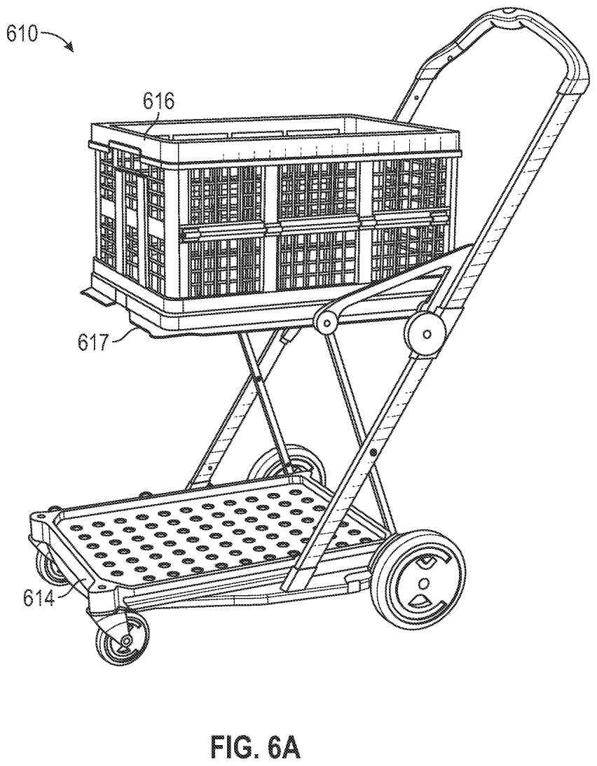

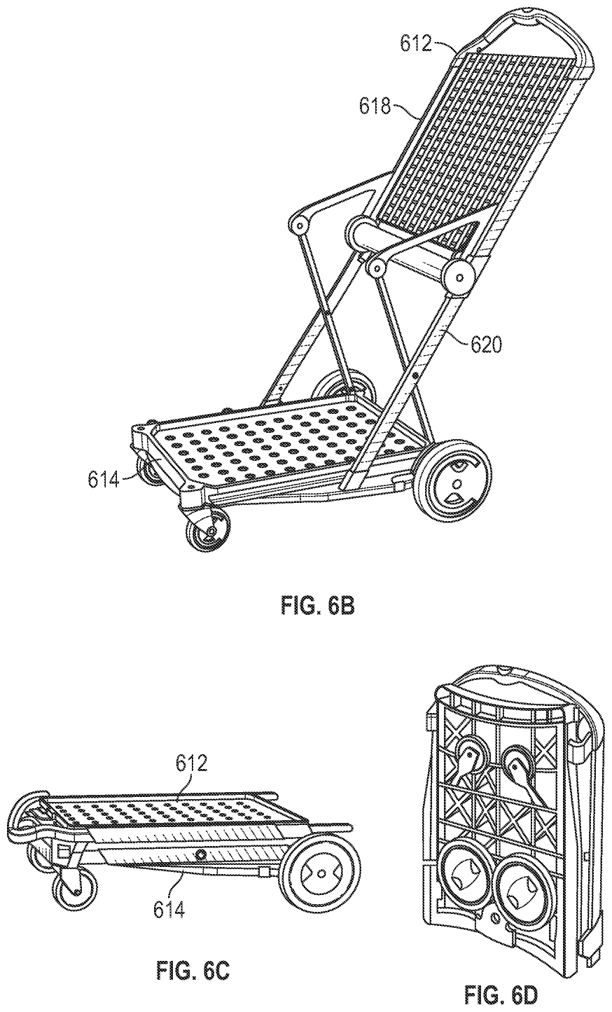

Referring now to FIGS. 6A-6D, another example of a foldable cart 610 is illustrated in various stages of folding. In this example, a first base 612 is disposed above a second base 614. A basket 616 is disposed on the first base 612. The basket 616 is removable and the first base 612 folds as illustrated in the position 618 in FIG. 6B. The first base 612 at position 618 is partially folded. As illustrated in FIGS. 6A-6D, the first base 612 is adjacent to the second base 614.

In FIGS. 6A-6D, arms 620 are foldable to allow the base 612 to fold adjacent to the base 614. In this manner, the cart 610 is inserted and coupled to the rails 22 as illustrated above in FIG. 1A.

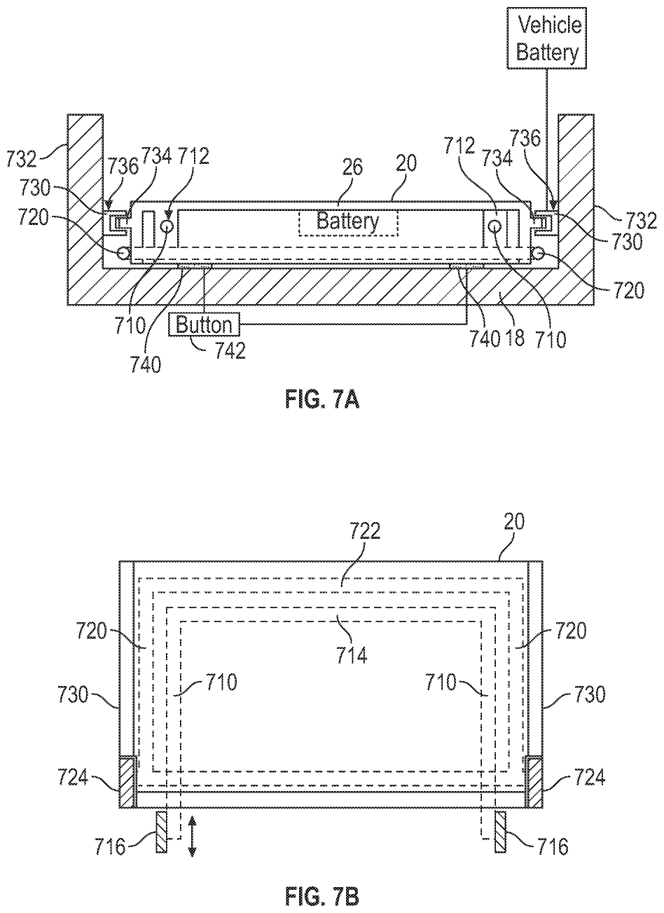

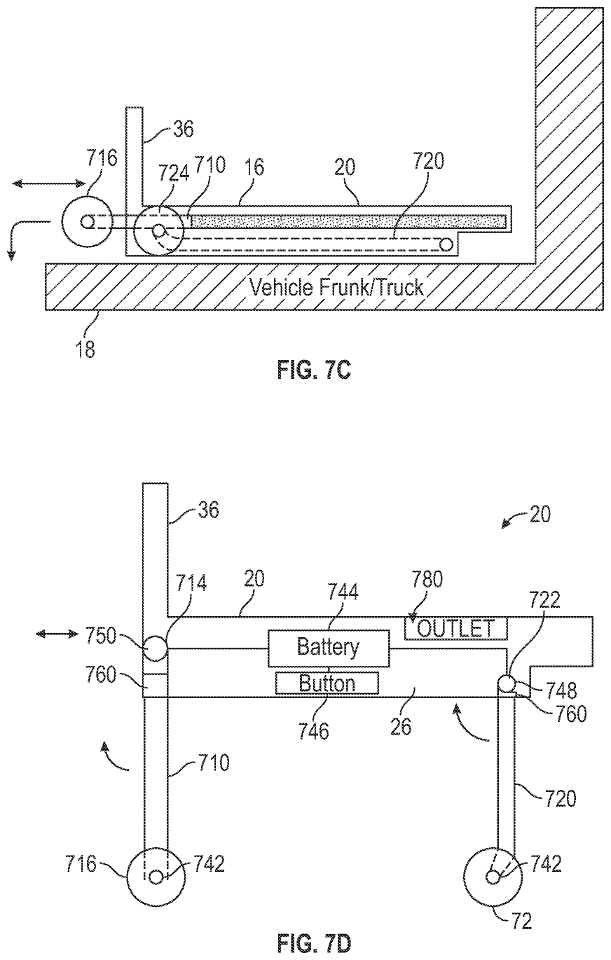

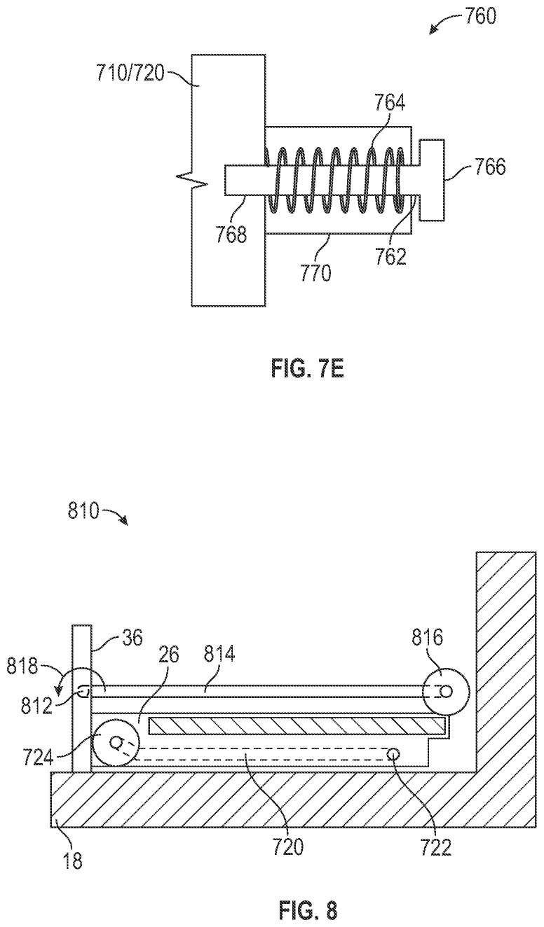

Referring now to FIG. 7A-7C, views of the cart 20 adjacent to a load floor 18 as set forth in the foldable position is illustrated. Details of the cart are further illustrated in FIGS. 7A-7D. The base 26 and the underside thereof receive at least a portion of the legs 710, 720. That is, the cart has a first pair of legs 710 that are disposed in a back wheel leg channel 712. The legs 710 have a cross-member 714. The legs 710 also have wheels 716 extending therefrom. The wheels 716 are the rear wheels of the cart. A second pair of legs 720 have a cross-member 722 extending therebetween. The cross-member 722 and the legs 720 form the front legs with front wheels 724 extending therefrom.

In this example, rails 730 are disposed on respective sidewalls 732. The rails 730, in this example, are U-shaped rails. Extensions 734 extend laterally from the base 26 and are received within the rail 730. The rails 730 and the extensions 734 form first engagement member 736 and a second engagement member 736 that are spaced apart and located on opposite sides of the cargo area 11. The extensions 734 slidably engage the rails 730 so that the cart 20 is slid rearward and forward as needed to remove the cart and replace the cart 20 relative to the load floor 18 within the vehicle 10. The engagement members 736 secure the cart 20 within the cargo area during operation of the vehicle 10.

Referring now also to FIG. 7D, the cart 20 is illustrated having the legs 710 and 720 in an unretracted or deployed position. The rear wheels 716 and 724 are extended in a downward position. The legs pivot about the cross-members 714 and 722 to fold in the manner illustrated in FIG. 7B. Further, in FIG. 7A, rollers 740 are disposed at the load floor to facilitate the slidability of the cart 20 into and out of the vehicle 10. The rollers 740 have a button 746 that controls the starting of operation. The rollers 740 are free spinning rollers or motorized rollers. If motorized, the rollers are operated with the assistance of pressing a button 746 so that the cart 20 may be easily retracted from the deployed position or inserted into the vehicle with the assistance of the rollers pushing the cart in the desired direction.

Referring back to FIG. 7D, various aspects of the cart may be powered. That is, a motor 742 may be located at one or more of the wheels 716, 724 so that a motive force from the motor 742 is used to drive the cart 20. The motors 742 may be powered by a battery 744. The motors 742 may be operated by a button 746 that allows various speeds to be obtained by the motors 742. A motor 748 may be coupled to the cross-members 722 to allow rotational force and automated folding and unfolding of the legs 720. Likewise, a motor 750 may be located at the cross-member 714 to allow the rear legs 710 to be retracted into or partially into the base 26.

Referring now to FIGS. 7D and 7E, a latch 760 may be used at each of the legs 720, 710 to allow the legs 710, 720 to be manually fixed into place in the deployed position. That is, a pin 762 that is biased by a spring 764 biased in the direction of the legs 710, 720 may be used. The pin 762 has a knob 766 that may be pulled by the operator to release the pins 762 from a hold or recess 768 within the legs 710, 720. It should be noted that one latch 760 may be located on each pair of legs 710, 720. However, a latch at each of the legs 710, 720 may be formed. That is, four latches may be used. A pin body 770 may be affixed on or at the base 26 to allow the pin 762 to be positioned adjacent to the legs 710, 720.

The latch 760 may also be used to fix the base 26 to the rails 22.

Referring back to FIG. 7D, the battery 744 may have an outlet 780 coupled thereto. The outlet 780 may be a wireless charging port or a wired port. The wired outlet 780 allows different devices to be charged or operated from the battery power 744.

Referring now to FIG. 8, another way to fold a cart 810 is illustrated. In this example, the handle 36 has a pivot point 812 used for folding legs 814. The legs 814 are the rearward legs that have wheels 816 extending therefrom. The legs unfold in the direction indicated by the arrow 818. The legs 720 may operate relative to the cross-member 722 and rotate thereabout in the same manner as that described above and therefore the legs 720, the cross-member 722 and the wheels 724 are labeled as above and will not be described any further. In this example, the legs 814 are disposed above the planar surface of the base 26. The legs 814 rotate 270° from the folded position illustrated in FIG. 8 to the unfolded or deployed position similar to that illustrated in FIG. 7D.

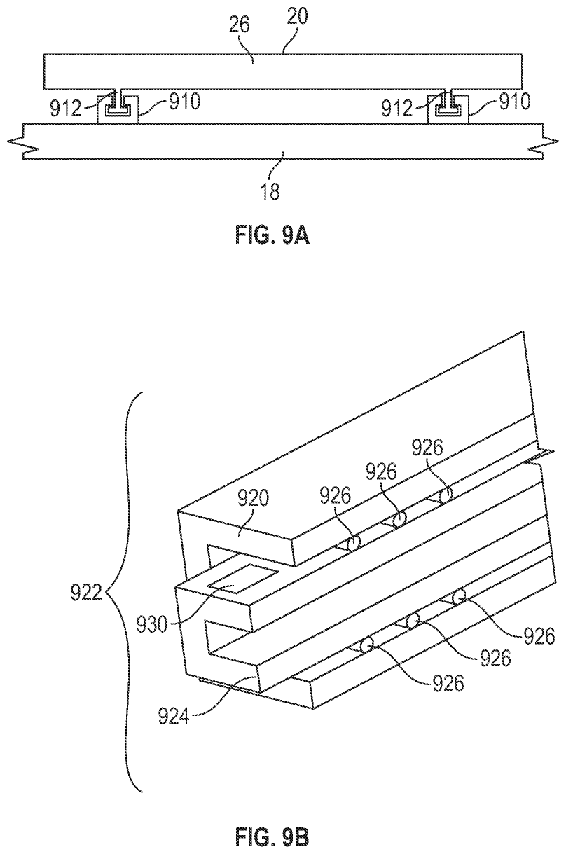

Referring now to FIG. 9A, rails 910 are illustrated coupled to the load floor 18. The rails 910 may receive extensions 912 to allow the cart 20 to extend inward and outward relative to the page. The rails 910, in this example, are C-shaped.

Referring now to FIG. 9B, an enlarged view of a rail 920 coupled to side wall 922 of the vehicle 10 is set forth and forms a channel. In this example, the first rail 920 has a second rail 924 slidably extending therefrom. Bearings 926 or another movement device (lubricant) to facilitate sliding movement the rails 920, 924. The inner rail 924 may allow further extension and coupling to the cart 20 so that cart 20 is extended further from the vehicle 10 to allow the cart 20 more easily clear and be removed from the vehicle 10. Latch 930, such as the latch illustrated in FIG. 7E, can be used to secure the cart 20 to one or both of the rails 920,924. Sets of rails 920, 924 may be located on both sides of the vehicle 10 to replace rails 22.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a load floor in a cargo area;
a first engagement member and a second engagement member disposed within the cargo area, the first engagement member spaced apart from the second engagement member; and
a cart having a base, a first side slidably engaging the first engagement member and a second side slidable engaging the second engagement member, said cart comprising legs retractably extending from the base and wheels coupled to the legs.

2. The vehicle of claim 1 wherein the first engagement member comprises a first rail and the second engagement member comprises a second rail, and wherein said cart comprises a first extension extending from the first side and engaging the first engagement member and second extension extending from the second side and engaging the second engagement member.

3. The vehicle of claim 2 wherein the first rail is coupled to a first sidewall and the second rail is coupled to the second sidewall.

4. The vehicle of claim 2 wherein the first rail and the second rail are coupled to the load floor.

5. The vehicle of claim 2 wherein the first rail and the second rail comprises an inner rail slidably extending therefrom, said inner rail coupling to the cart.

6. The vehicle of claim 1 wherein the cargo area comprises a front trunk.

7. The vehicle of claim 1 wherein the cargo area comprises a rear trunk or a cargo bed.

8. The vehicle of claim 1 wherein the base comprises a planar surface.

9. The vehicle of claim 8 wherein the base comprises foldable walls coupled to the planar surface.

10. The vehicle of claim 9 wherein the foldable walls comprise a pair of longitudinally extending walls.

11. The vehicle of claim 10 wherein the foldable walls comprise a pair of laterally extending walls.

12. The vehicle of claim 1 wherein the base comprises a toolbox.

13. The vehicle of claim 1 wherein the load floor comprises roller adjacent to the cart.

14. The vehicle of claim 1 wherein the cart comprises a first pair of legs and a second pair of legs.

15. The vehicle of claim 14 wherein the first pair of legs comprises a first deployed position and a first retracted position and the second pair of legs comprises a second deployed position and a second retracted position.

16. The vehicle of claim 15 further comprising a first pair of wheels coupled to the first pair of legs and a second pair of wheel coupled to the second pair of legs.

17. The vehicle of claim 16 wherein the first pair of legs are coupled to a handle and rotate 270 degrees.

18. The vehicle of claim 16 wherein the first pair of legs and the second pair of legs are disposed below the cart in a retracted position and in a deployed position.

19. The vehicle of claim 18 further comprising a lock engaging at least one of the first pair of legs and at least one of the second pair of legs in the first deployed position.

20. The vehicle of claim 1 wherein the base comprises a battery coupled thereto, said battery coupled to a motor, said motor coupled to drive at least one wheel of the first set of wheels and the second set of wheels.
